(19) United States
(12) Patent Application Publication
(10) Pub. No.: US 2007/0204014 A1
(43) Pub. Date: Aug. 30, 2007

(54) Mobile Webcasting of Multimedia and Geographic Position for a Real-Time Web Log

(76) Inventors: John Wesley Greer, Boulder, CO (US); David Michael Rheingold, New York, NY (US); Nico Toutenhoofd, Boulder, CO (US)

Correspondence Address: LEE & HAYES, PLLC, 421 W. RIVERSIDE AVE, STE 500, SPOKANE, WA, 99201, US

(21) Appl. No.: 11/679,502

(22) Filed: Feb. 27, 2007

Related U.S. Application Data
(60) Provisional application No. 60/743,377, filed on Feb. 28, 2006.

(51) Int. Cl. G06F 15/16

(52) U.S. Cl. 709/219

(57) ABSTRACT

Systems and methods for mobile webcasting of multimedia and geographic position for a real-time web log are described. In one aspect, the systems and methods capture multimedia at multiple consecutive geographical locations during a web logging session. The systems and methods also acquire geographical position data corresponding to multiple geographical positions or locations where the multimedia was and is currently being captured. The systems and methods communicate the multimedia and geographical position data to a central server to update webpage(s) of a web site. An end-user interfacing with a web site browser application accesses the webpage(s) for real-time presentation of the multimedia and geographical position data.

### RELATED APPLICATIONS

This patent application claims priority to U.S. provisional patent application Ser. No. 60/743,377, filed on Feb. 28, 2006, titled “Web Site Mobile Updating and Interface,” hereby incorporated by reference.

### BACKGROUND

While a provider is acquiring multimedia, the multimedia is commonly streamed for receipt and presentation to end-users. A webcast, which is typically associated with non-interactive linear streams or live events, generally uses streaming media technology to take a single content source and distribute it to many simultaneous listeners/viewers. The ability to webcast using inexpensive and accessible technology has allowed independent media to flourish. Often produced by average citizens in their homes or from production studios, webcasts cover many interests and topics. There are many notable independent shows, presentations, seminars, etc., that broadcast regularly online.

### SUMMARY

Systems and methods for mobile webcasting of multimedia and geographic position for a real-time web log are described. In one aspect, the systems and methods capture multimedia at multiple consecutive geographical locations during a web logging session. The systems and methods also acquire geographical position data corresponding to multiple geographical positions or locations where the multimedia was and is currently being captured. The systems and methods communicate the multimedia and geographical position data to a central server to update webpage(s) of a web site. An end-user interfacing with a web site browser application accesses the webpage(s) for real-time presentation of the multimedia and geographical position data.

This Summary is provided to introduce, in a simplified form, a selection of concepts that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for mobile webcasting of multimedia and geographic position for a real-time web log, according to one embodiment.

FIG. 2 shows an exemplary webpage for a “As Seen by <name, symbol, etc., here>” or “Where's It Happening” user interface (UI) presented by a web site, according to one embodiment.

FIG. 3 shows another webpage for a “As Seen by <name, symbol, etc., here>”, or a “Where's It Happening” UI associated with a web site, according to one embodiment.

FIG. 4 shows an exemplary procedure for mobile webcasting of multimedia and geographic position for a real-time web log by a portable computing device, according to one implementation.

FIG. 5 shows an exemplary procedure for mobile webcasting of multimedia and geographic position for a real-time web log by a web server, according to one implementation.

### DETAILED DESCRIPTION

### Overview

Conventional webcasting is typically restricted to a single location, for example, in a home or studio environment. In contrast, the following described systems and methods for mobile webcasting of real-time multimedia and geographic position allow a user to generate and present a portable web log conveying what is actually being seen, or otherwise experienced, by the user at any time as the user is traveling from one geographical location to another. Specifically, the systems and methods provide the user with sensors to capture multimedia (audio and video) and geographical position data (e.g., latitude and longitude and/or Universal Transverse Mercator (UTM) coordinates) indicating where the multimedia is being acquired at any one moment in time. The systems and methods wirelessly communicate the captured data to a central server to update webpage(s) of a real-time web log presented by a web site. An end-user (viewer) interfacing with a web site browser application accesses the webpage(s) to determine whether real-time presentation of the captured data is currently available. If this presentation is available, the end-user may view the captured multimedia and geographical position data in real-time. In one implementation, one webpage (or more) of the real-time web log presents configurable map views (e.g., a street, satellite, and/or hybrid map view) that show a viewer where the user (the “web logger”) has traveled during a current web logging session, and from which location the web logger is currently webcasting.

### An Exemplary System

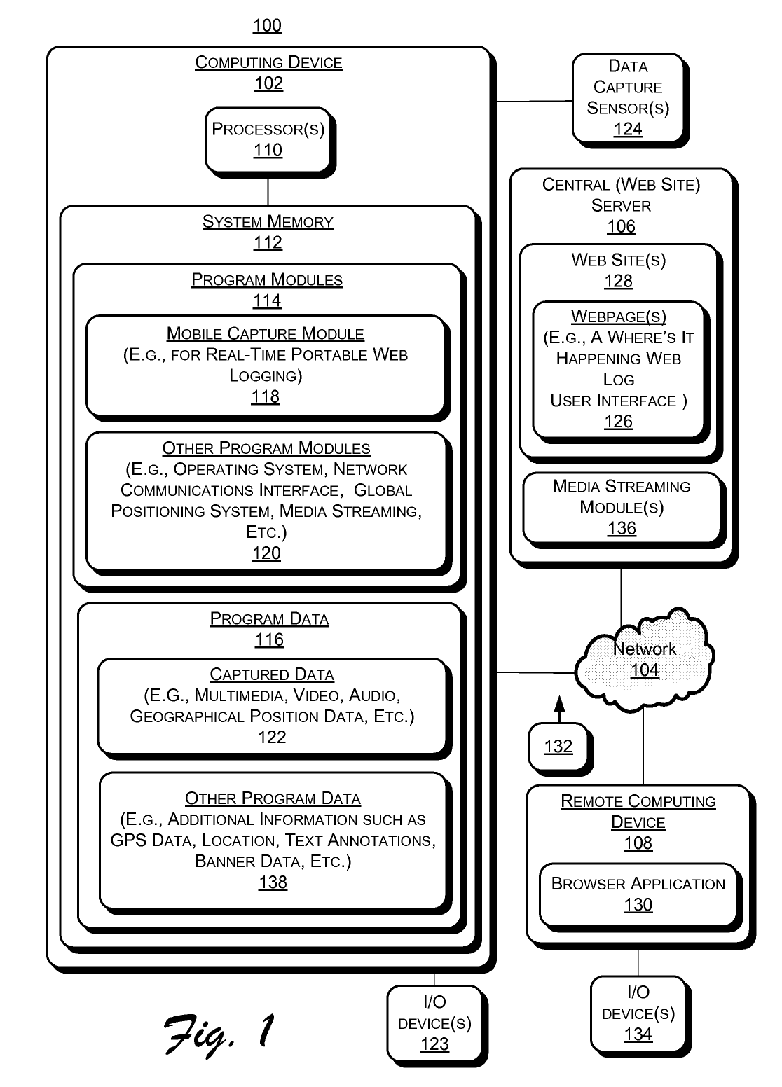

FIG. 1 shows an exemplary system 100 for mobile webcasting of multimedia and geographical position for a real-time web log, according to one embodiment. In this implementation, FIG. 1 includes, for example, a computing device 102 coupled across network 104 to central server 106 and remote computing device 108. In this implementation, computing device 102 is a portable computing device such as a laptop computer, a small-form factor-computing device such as a personal digital assistant (PDA), etc., that can be carried by a user. In this implementation, for example, computing device 102 is a laptop computer that is carried, for example, in a backpack by the user. Central server computing device 106 and remote computing device 108 represent, for example, any one or more of a server, a general-purpose computing device such as a personal computer (PC), a laptop, a mobile computing device, and/or so on. Whereas computing device 102 is a portable computing device, there is no such constraint for central server 106 and remote computing device 108.

Each computing device 102, 106, and 108 respectively includes one or more processors coupled to system memory comprising computer-program modules executable by respective ones of the processor(s). Such system memory also includes program data generated and/or used by respective ones of the computer-program instructions during program module execution. For example, computing device 102 includes one or more processors 110 coupled to system memory 112 representing volatile random access memory (RAM) and non-volatile read-only memory (ROM). System memory 112 includes program modules 114 comprising computer-program instructions executable by processor(s) 110. System memory 112 also includes program data 116 generated and/or used by respective ones of the computer-program instructions during program module execution. In this implementation, for example, program models 114 include mobile capture module 118 and other program models 120 such as an operating system, network communication module, a data streaming application, global positioning system application(s), and/or so on. Exemplary operations for program modules 114 are now described.

Mobile capture module 118 is coupled to one or more data capture sensors 124 for capturing multimedia. For purposes of exemplary illustration, such captured multimedia is shown as a respective portion of “captured data” 122. In this implementation, for example, data capture sensors 124 include audio and video sensors for capturing video and audio data as a user travels to various geographical locations. Such sensors 124 represent, for example, optical sensors associated with a digital camera, optical sensors embedded in a pair of eyeglasses or other wearable item, a microphone, and/or so on. Techniques for capturing multimedia content using optical and/or audio sensors are known. Responsive to capture of multimedia (a respective portion of captured data 122) at various different geographical occasions by a user (a “web logger”) via mobile capture module 118, mobile capture module 118 automatically communicates captured data 122 along with additional information (e.g., geographic location information, text, etc.) across network 104 to central server 106. In one implementation, the user inputs arbitrary text data into the portable computing device 102 for communication to central server 106 and subsequent presentation, for example, on a banner (e.g., a rolling banner, etc.) on a webpage. Such text input can be via one or more I/O devices 123 such as a keyboard, a voice recognition computer-program, etc.

In this implementation, computing device 102 communicates or streams captured data 122, geographical position data (respective portions of program data 116) and any other data for presentation to a viewer (e.g., text, etc.) to central server 106 using a network interface, for example, a network interface card. Exemplary computer-executable instructions for such network communication and streaming interface(s) are shown, for example, as respective portions of “other program modules” 120. In this implementation, computing device 102 communicates at least the captured multimedia 122 to central server 106 using wireless communications over network 104.

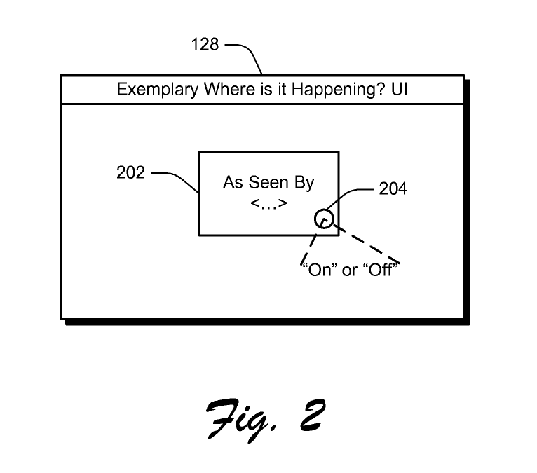

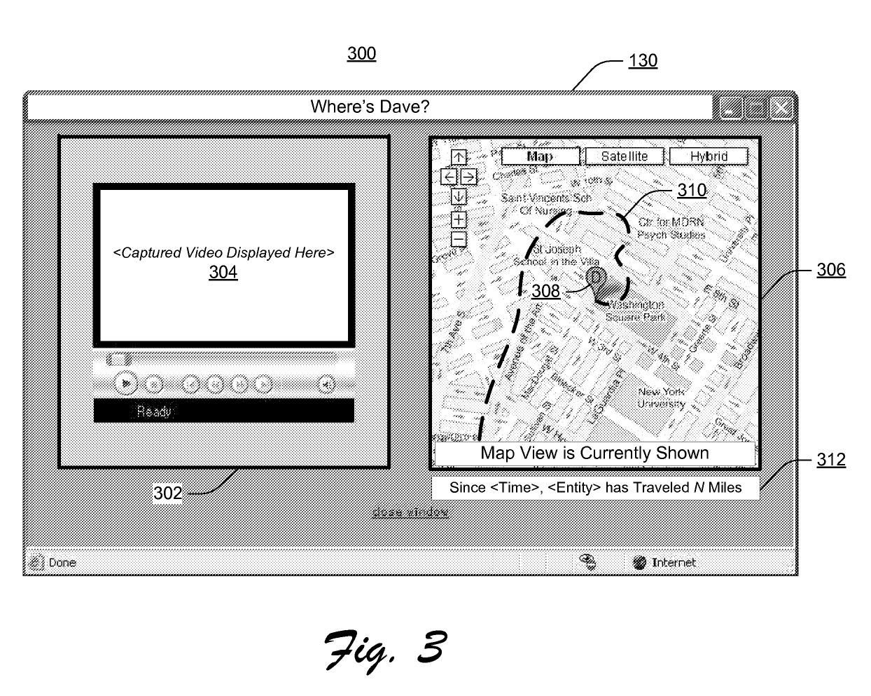

Responsive to receiving captured data 122 and additional information such as GPS-based location information, broadcast duration, banner text, and/or so on, from computing device 102, central server 106 updates webpage(s) 126 of website 128 in real-time. Exemplary visual aspects of webpage(s) 128 are described below in reference to FIGS. 2 and 3 (please see the section titled “An Exemplary User Interface”). A user of remote computing device 108 interfaces with browser application 130 to send a request (a respective request 132) to central server 106, and thereby, access (e.g., via a URI such as a URL) web site 126 and present webpage(s) 126 to a viewer. Responsive to receiving the request, central server 106 communicates webpage(s) 126 (e.g., via HTTP and HTML) to the requesting browser 130. In this implementation, webpage(s) 126 represent a “Where's It Happening?” or “Where's<the user>” UI, where “<the user>” represents a name, moniker, symbol, etc. associated with an entity capturing data 122. The specific name(s) or titles provided for these UI are exemplary, informative, and arbitrary. In this implementation, the user navigates webpage(s) 126 to play or stream multimedia portions of captured data 122 from central server 106 for viewing. Remote computing device 108 is coupled to one or more I/O devices 134 such as a display device, speakers, and/or so on, for presenting the multimedia portions and other corresponding information from webpage(s) 126 to the user.

In one implementation, and to show a viewer where captured data 122 is being acquired in real-time, computing device 102 is operatively coupled to a Global Positioning System (GPS) component. For purposes of exemplary illustration, a respective portion of data capture sensors 124 represents an on-board GPS component or a GPS component otherwise operatively coupled (e.g., via wireless communication, etc.) to computing device 102. For example, in one implementation, the GPS component is carried by a person that is geographically near computing device 102. The GPS component communicates GPS information (location coordinates, etc.) to computing device 102 for uploading to central server 106. Responsive to receiving such GPS information, central server 106 updates location data and corresponding information associated with webpage(s).

### An Exemplary User Interface

FIG. 2 shows an exemplary webpage 128 for a “As Seen by <name, symbol, etc., here>” or “Where's It Happening” UI presented by webpage(s) 128, according to one embodiment. The term “< . . . >”, in the phrase “As Seen by <name, symbol, etc., here>,” represents a name, moniker, symbol etc. associated with the particular entity (e.g., a person, animal, robot, etc.) that is in close proximity to captured data 122 acquiring operations. A person in “close proximity” to such operations can be, for example, the actual individual operating data capture sensors 124 to obtain multimedia for presentation on webpage 128, or a person in the same geographical location as a different entity operating data capture sensors 124 to obtain the multimedia. For purposes of exemplary illustration and description, the left-most numeral of a reference number indicates the first figure in the drawings where the particular component, operation or aspect was introduced. For example, the left-most numeral of webpage 128 is a “1,” which indicates that webpage 128 is the same component that was introduced and described with respect to FIG. 1.

Referring to FIG. 2, webpage 128 represents an exemplary home page of web site 126, although such a webpage could also represent a different webpage other than the home page of web site 126. In this implementation, for example, webpage 128 includes at least a UI component 202 that indicates to a viewer whether captured data 122 is being acquired at that moment for communication in real time (i.e., as it is acquired) to central server 106 for presentation to a viewer via another webpage 128 of web site 126 (e.g., please see FIG. 3). In one implementation, for example, UI component 202 is an icon or full-sized image shaped like a television set, display monitor, video camera, etc. As shown in this example, component 202 presents an indication 204 (e.g., “on” or “off”) of whether captured data 122 is actively being acquired, and thereby, provides a viewer with a real-time multimedia/information receiving and updating status. When status associated with the component 204 indicates that the web site 126 is being updated in real time (i.e., with captured data 122, GPS information, etc.), in this implementation, the viewer can select object 202 or 204 to navigate to another webpage 128 to view captured data 122, etc.

FIG. 3 shows another webpage 128 for a “As Seen by <name, symbol, etc., here>,” or a “Where's It Happening” UI associated with web site 126, according to one embodiment. In this exemplary implementation, this webpage of web site 126 illustrates:
An exemplary multimedia (audio and video) player 302 for presenting captured data 122 (FIG. 1) to a viewer.
Presented video content 304 (a respective reconstructed portion of captured data 122). Although this example of presented video content 304 is shown as a white region, it can be appreciated that presented video 304 characterizes a reconstructed sequence of still images representing scenes in motion.
A view 306 showing a geographical area indicating where captured data 122 is being acquired. Although this example illustrates a street map view, such an area can also be illustrated with other backdrops such as a satellite (remote image based) view or a hybrid view (i.e., a satellite image annotated with street names, etc.). In this implementation, button controls respectively titled “Map,” “Satellite,” and “Hybrid” allow a viewer to toggle between respective ones of a map view, a satellite view, and a hybrid view.
A current position or location 308 indicating where the multimedia 122 is being captured at that particular time within the view area (e.g., within a street map, satellite or hybrid view). In this example, the current location 308 is a teardrop icon annotated with a letter “D” pointing to the corner of MacDougal Street and West 4th Street on a street map, wherein “D” represents “Dave”—the entity (in this example) that is acquiring captured data 122.
A capture path 310 showing a route where captured data 122 has been acquired over time, including where captured data 122 is currently being acquired. In this implementation, path 310 is a dotted line that ends at current position/location 308; and
An odometer 310 indicating a distance over which captured data 122 has been acquired in a current broadcast session. A broadcast session refers to actions of acquiring and uploading captured data and other information (e.g., GPS data, etc.) to central server 106 for an arbitrary amount of time for presentation to a user via web site 126. In this implementation, odometer 310 shows that “since <a start broadcast time>,” “<a particular entity> has traveled N miles”; the particular entity acquiring captured data 122 for uploading and presenting to a user via the web site 126. As a user/entity travels with computing device 102, captured data 122 and GPS information is communicated to central server 106, responsive to which central server 106 updates indications 306 through 312 for web site 126, accordingly.

### Exemplary Procedure

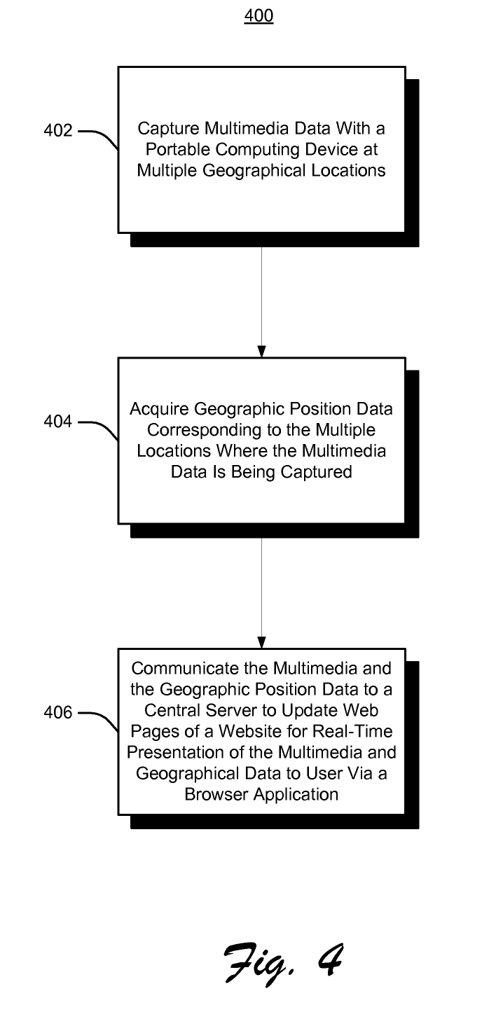

FIG. 4 shows an exemplary procedure 400 for mobile webcasting of multimedia and geographic position for a real-time web log, according to one implementation. In one implementation, operations of procedure 400 are implemented by respective program modules 114 of computing device 102 of FIG. 1. For purposes of exemplary illustration and description, the operations of procedure 300 are described with respect to the components and various aspects of FIGS. 1 through 3. In this description, the left-most numeral of a component/operation (step) reference number represents the figure in which the component/operation was first introduced.

Operations of block 402 capture multimedia (respective portions of captured data 122) with a portable computing device 102 at multiple geographical locations (e.g., please see the travel path 310 of FIG. 3). In one implementation, for example, the portable computing device is carried by a user, for example, in a backpack. The multimedia is captured with data capture sensors 124 embedded, for example, in a pair of eyeglasses, a digital video camera, or any one or more portable video and audio capture devices. The captured multimedia represents what is seen, or otherwise experienced (e.g., heard), by the user at the multiple geographical locations during one or more consecutive/sequential broadcast sessions.

Operations of block 404 acquire geographical data corresponding to the multiple locations where the multimedia is being captured. Such geographical data is shown, in one implementation, as a respective portion of captured data 122. In another implementation, such geographical data is shown as respective portion of “other program data” 138. In one implementation, the geographical data is acquired by a GPS device directly coupled or remotely coupled to the portable computing device 102.

Operations of block 406 communicate the multimedia and geographical position data to a central server 106 (a Web server) to update webpage(s) 126 of the website 128 for real-time presentation of the multimedia and geographical position data to the user via a browser application 130. In one implementation, a webpage 126 includes odometer 312 displaying distance information associated with a travel-path over which the multimedia has been captured. In one implementation, the odometer display 312 is text-based. In another implementation, the odometer display 312 is based on a graphic. The webpage 126 may also present a map view 306 of a region indicating where the multimedia is being captured over time. Such a map view may present, for example, a street map, a satellite image of the region, and/or a hybrid view of the region (e.g., a satellite image annotated with text indicating streets, etc.). Additionally, webpage 126, in one implementation, includes a capture path 310 identifying a route associated with multimedia acquisition operations over time.

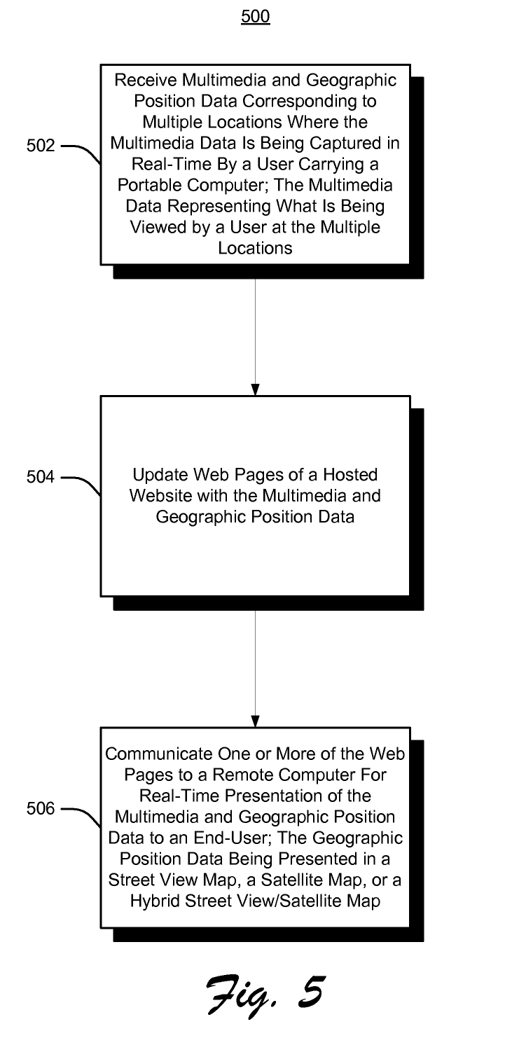

FIG. 5 shows another exemplary procedure 500 for mobile webcasting of real-time multimedia and geographic position data for a real-time web log, according to one implementation. In one implementation, operations of procedure 500 are implemented by respective program modules of a central server 106 of FIG. 1. For purposes of exemplary illustration and description, the operations of procedure 500 are described with respect to the components and various aspects of FIGS. 1 through 3. In this description, the left-most numeral of a component/operation (step) reference number represents the figure in which the component/operation was first introduced.

Referring to FIG. 5, operations of block 502 receive multimedia and geographical position data (e.g., respective portions of captured data 122 and/or “other program data” 138) corresponding to multiple locations where the multimedia is being captured by a user in real-time. For purposes of exemplary illustration, such multiple geographical locations are illustrated by travel path 310 FIG. 3. Operations of block 504 update webpages 126 of a hosted website 128 with the captured multimedia and geographical position data. Exemplary such webpages 126 are shown and described above with respect to FIGS. 2 and 3.

Operations of block 506 communicate one webpage 126 (or more) to a remote computer 108 for real-time presentation of the captured multimedia and geographical position data to an end-user. For example, a well-known HTTP protocol is used to communicate a webpage 126 described with well-known HTML syntax and constructs. The multimedia is presented (e.g. via streaming operations) by multimedia player logic associated with a webpage. The geographical data are presented at the remote computing device 108 in a map view 306 representing a street view map, a satellite map, or a hybrid street view/satellite map. In one implementation, the map view 306 is associated with odometer 312 displaying distance information associated with a travel-path over which the multimedia and geographical position data have been captured. In one implementation, the odometer display 312 is text-based. In another implementation, the odometer display 312 is based on a graphic, or some combination of text and graphic. Additionally, and in one implementation, capture path 310 is presented on top of map view 306 to indicate a specific route where the multimedia acquisition operations have occurred (and are occurring) with respect to time. In one implementation, for example, capture path 310 is a dotted line.

### CONCLUSION

Although the above sections describe mobile webcasting of multimedia and geographic position for a real-time web log in language specific to structural features and/or methodological operations or actions, the implementations defined in the appended claims are not necessarily limited to the specific features or actions described. Rather, the specific features and operations for mobile webcasting of multimedia and geographic position for a real-time web log are disclosed as exemplary forms of implementing the claimed subject matter.

1. A computer-implemented method comprising:
capturing, by a portable computing device, multimedia at multiple consecutive geographical locations during a web logging session;
acquiring, by a GPS component, geographical position data corresponding to at least a subset of the multiple consecutive geographical locations;
communicating at least the multimedia and the geographical position data to a central server for updating webpage(s) of a web site; and
wherein the webpage(s) are for real-time presentation of the multimedia and geographical position data to a user via a browser application.

2. The method of claim 1, wherein the portable computing device is carried by a user in a backpack.

3. The method of claim 1, wherein the multimedia is captured with data capture sensors embedded in a pair of eyeglasses, the data capture sensors being operatively coupled to the portable computing device.

4. The method of claim 1, wherein the multimedia represents what is seen and/or heard by a user carrying the portable computing device.

5. The method of claim 1, wherein the webpage(s) allow a user to navigate to a presentation of the multimedia and the geographical position data.

6. The method of claim 5, wherein the presentation includes an odometer displaying a distance over which the multimedia has been acquired in a broadcast session.

7. The method of claim 5, wherein a multimedia player presents the multimedia, and wherein a map view of a region indicates where the multimedia is being captured.

8. The method of claim 7, wherein a webpage control allows a user to change the map view to each of a street view, a satellite view, and a hybrid view.

9. The method of claim 7, wherein the map view comprises a capture path to indicate a route where the multimedia has been acquired over time.

10. The method of claim 7, wherein the map view comprises an icon indicating a current location where the multimedia is being acquired in real-time.

11. A tangible computer-readable medium comprising computer-program instructions executable by a processor, the computer-program instructions when executed by the processor for performing operations including:
receiving multimedia and geographical position data, the geographical position data corresponding to multiple locations where the multimedia is being captured in real-time;
updating webpage(s) of a hosted web site with the multimedia and the geographical position data;
responsive to receiving a request from a remote computing device to access the hosted web site, communicating information for presentation of one or more of the webpage(s) to the remote computer; and
responsive to receiving one or more requests to present one or more of the multimedia and the geographical data:
streaming the multimedia for real-time presentation to an end-user, the real-time presentation being on a webpage of the webpage(s); and
communicating the geographical position data for real-time display to the end-user of user interface elements associated with the geographical position data on a webpage of the webpage(s).

12. The computer-readable medium of claim 11, wherein the multimedia represents what is seen and/or heard by a user carrying a portable computing device to each of the multiple locations.

13. The computer-readable medium of claim 11, wherein the real-time display includes an odometer displaying a distance over which the multimedia has been acquired at each of the multiple locations.

14. The computer-readable medium of claim 11, wherein a page of the webpage(s) includes a map view of a geographical region to indicate where the multimedia has been and is being captured.

15. The computer-readable medium of claim 14, wherein the page includes a user interface control to allow the end-user to change the map view to a street view, a satellite view, and a hybrid view.

16. The computer-readable medium of claim 14, wherein the map view comprises a capture path to indicate a route where the multimedia was acquired over time and where the multimedia is currently being acquired.

17. The computer-readable medium of claim 14, wherein the map view comprises an icon indicating a current location where the multimedia is being acquired in real-time.

18. A portable computing device comprising:
a processor; and
a memory coupled to the processor, the memory comprising computer-program instructions executable by the processor for performing steps comprising:
capturing multimedia, the multimedia representing what is being viewed by an entity carrying the portable computing device at multiple different geographical locations;
acquiring global positioning data identifying respective ones of the multiple different geographical locations;
communicating the multimedia and the global positioning data to a web site server to update webpage(s) of a web site; and
wherein the webpage(s) are for real-time presentation of the multimedia and global positioning data to a user via a browser application.

19. The portable computing device of claim 18, wherein the multimedia is captured with data capture sensors embedded in a pair of eyeglasses, the data capture sensors being operatively coupled to the portable computing device.

20. The portable computing device of claim 18, wherein the webpages(s) comprise:
an odometer displaying a distance over which the multimedia has been acquired in a broadcast session;
a multimedia player to present the multimedia;
a map view of a region indicates where the multimedia is being captured, the map view including a capture path and an icon, the capture path indicating a route where the multimedia has been acquired over time, the icon displaying a current location where the multimedia is being acquired in real-time; and
a webpage control to allow a user to change the map view to each of a street view, a satellite view, and a hybrid view.
